(19) United States
(12) Patent Application Publication
(10) Pub. No.: US 2005/0108679 A1
(43) Pub. Date: May 19, 2005

(54) Method and system for managing document processing device job information

(76) Inventors: C. Troy Jensen, Caldwell, ID (US); Jeffrey D. Hall, Meridian, ID (US)

Correspondence Address: HEWLETT-PACKARD COMPANY;Intellectual Property Administration, P.O. Box 272400, Fort Collins, CO, 80527-2400, US

(21) Appl. No.: 10/715,951

(22) Filed: Nov. 17, 2003

(51) Int. Cl. G06F 9/44

(52) U.S. Cl. 717/101; 717/168; 717/169

(57) ABSTRACT

A method and system of providing document processing device job information, includes organizing the job information into menus and submenus and displaying the job information to a user.

### BACKGROUND

With a personal computer and an appropriate software package, a user can produce virtually any type of desired document. For example, word processing software may be used to produce text documents, graphic design or computer-aided design software can be used to produce diagrams, charts, graphs, or designs, and spreadsheet software allows a user to manage large amounts of financial and other types of information. Similarly, database software may be used to manage various databases of information such as client contact information, address and phone number information, or “to do” items.

Frequently, it is desirable to generate a “hardcopy” of a document or data set that has been produced or stored on a personal computer. A hardcopy may be desired, for example, for record keeping purposes or to share with another party. Consequently, a wide variety of printers and document processing devices have been developed to receive a print job from a host computer and produce a hardcopy of a document or data set. Additionally, hardcopies may be created by replicating one or more existing hardcopies. Conversely, a hardcopy may be transferred to a softcopy by scanning a hardcopy and storing it as a digital data set.

In order to save space, particularly in home offices, many users employ a multifunction device (MFD) that performs two or more functions including printing, scanning, copying, faxing, digitally sending (including email, send to network drive, scan to host), etc. An MFD may receive a document or data set and print it, scan it, copy it, fax it, digitally send it, etc. depending on the user's request. While the ability of an MFD to perform multiple functions for multiple users both increases efficiency and saves space, these same abilities often produce organizational issues between users.

### SUMMARY

A method and system of providing document processing job information, includes organizing the job information into menus and submenus and displaying the job information to a user.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a block diagram illustrating a system for interacting with a document processing device according to one exemplary embodiment.

FIG. 2 illustrates a sample user interface display comprising menus and submenus according to one exemplary embodiment.

FIG. 3 illustrates a sample user interface display comprising menus and submenus according to an alternative embodiment.

FIG. 4 illustrates a sample user interface display comprising menus and submenus according to an alternative embodiment.

Throughout the drawings, identical reference numbers designate similar, but not necessarily identical, elements.

### DETAILED DESCRIPTION

The present specification describes a method and a system for managing job information on a document processing device. More particularly, the present specification presents a system and a method for organizing document processing information into menus and submenus while displaying the document processing information to a user.

In the following description, for purposes of explanation, numerous specific details are set forth in order to provide a thorough understanding of the present system and method. It will be apparent, however, to one skilled in the art that the present system and method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Both here and in the appended claims, the term “print job” is meant to be understood as data that has been prepared for printing by a document processing device. Similarly, the more general term, “job” is meant to be understood as data, in the form of a file or a document, which has been prepared for handling by a multi-function device or other document processing device.

As used both in the present specification and in the appended claims, the term “document processing device” is defined as any device configured to processes a document or data set to produce either a hardcopy or a softcopy from electronic data including, but in no way limited to, laser printers, inkjet printers, dot matrix printers, plotters, facsimile machines, digital copiers, photocopiers, multifunction devices (MFDs), scanners, digital senders, etc. For ease of explanation only, the present system and method will be described in the context of an MFD. Moreover, the above-mentioned document processing device may produce images on a variety of print media and may produce images that are in color or are monochromatic.

In a business office, school, or other location, a multifunction device (MFD) or other document processing device may receive numerous requests per day to print, copy, scan, digitally send, and/or fax a file or document. Often, two or more jobs will arrive at the MFD simultaneously. Additionally, there may be one or more users employing various functions on the MFD simultaneous with the arrival of other job requests. When multiple requests have been made of a single MFD, a user may desire to know the progress status of a job that was to be handled by the document processing device. The following system and method presents an organization including menus and submenus containing job information, such as a job's progress status, that may be displayed to and/or viewed by a user.

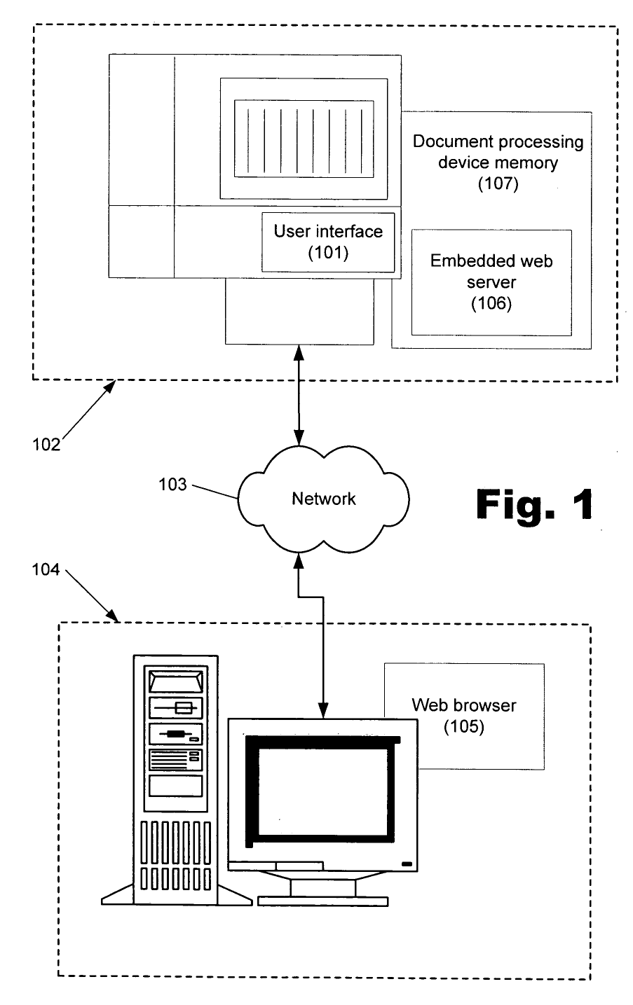

As shown in FIG. 1, a document processing device (102) such as an MFD may be communicatively coupled to a user terminal (104) through a network (103). The network coupling the user terminal (104) to the document processing device (102) may be, but is in no way limited to, a local area network (LAN), an intranet, the Internet, etc. The user of a document processing device (102) may send a job request along with the necessary data to the document processing device (102) via the network (103) for processing. By way of example, if the document processing device (102) is an MFD, the user may specify whether to print, copy, fax, scan, digitally send, or perform any combination of these functions with the document or file. Alternatively, the user may operate the document processing device (102) at the physical location of the document processing device (102) using a user interface (101).

The user terminal (104), illustrated in FIG. 1, may be any computing device capable of transmitting a file or a document through a network (103) to a document processing device (102) where it may be processed. The user terminal (104) may include, but is in no way limited to, a personal computer, a work-station, a laptop, a server, a personal digital assistant (PDA), a cellular telephone, etc. As shown in FIG. 1, the user terminal (104) may include a web browser (105). A web browser (105) is a client program that uses the Hypertext Transfer Protocol (HTTP) to make requests of web servers throughout the Internet on behalf of the browser user. Additionally, some web browsers (105) also support e-mail (indirectly through e-mail web sites) and the File Transfer Protocol (FTP). However, the present web browser (105) is not necessarily required to support e-mail or the FTP according to the present system and method.

Turning now to the document processing device (102) illustrated in FIG. 1, the document processing device (102) may include a user interface (101) and a memory unit (107) that includes an embedded web server (106). The document processing device (102) may be a multifunction device, a copy machine, a printer, a scanner and/or any other document processing device (102) that implements some type of user interface for interaction with the device (102).

As shown in FIG. 1, the MFD or other document processing device (102) may include a memory unit (107) that contains an embedded web server (106) for communicating with other computers or document processing devices. The phrase “embedded web server” refers to a set of computer-readable instructions (e.g., software or firmware) for providing a document processing device with the function or capability of sending data or providing information via a web page. According to one exemplary embodiment, the embedded web server (106) will incorporate document processing device information as well as job information into a web page, which may be viewed with a web browser (105). In this manner, job status information maybe viewed remotely on a user terminal (104).

Additionally, the document processing device (102) may include a number of drivers (not shown) such as an MFD driver. An MFD driver (not shown) is a piece of software or firmware capable of formatting data to be handled by the MFD. Alternatively, the MFD may receive data that has been processed by an MFD driver at another location. Such a driver may reside on the MFD itself or on a remote user terminal (104).

Similar to most document processing devices, the present document processing device (102) may also employ some type of user interface (101) to facilitate human interaction with the document processing device. The user interface (101) illustrated in FIG. 1 enables a user to view and/or input configuration settings or other information into the document processing device. The user interface (101) may include, but is in no way limited to, a touchpad, a keypad, a mouse, a keyboard, a viewable screen, a touch screen panel, menus, tabs or other means of displaying and/or navigating through a list of available options and/or job information.

Job information displayed on the user interface (101) may include, but is in no way limited to, job progress status, job type, job size, number of pages in requested job, date job request was received, time job request was received, process details, job request sender, job recipient, location job request was sent from, desired destination of job request, etc. Additional information that may be available through the job management menus may include queue information when multiple jobs are waiting to be processed by the document processing device. For example, if a user is making a copy at the document processing device and two additional jobs come in over the network (103), the two additional jobs may be put in a queue and handled according to precedence. Additionally, the user interface (101) may display job confirmation data indicating the date and time the processing of a request occurred, or view the progress status of a job currently being processed.

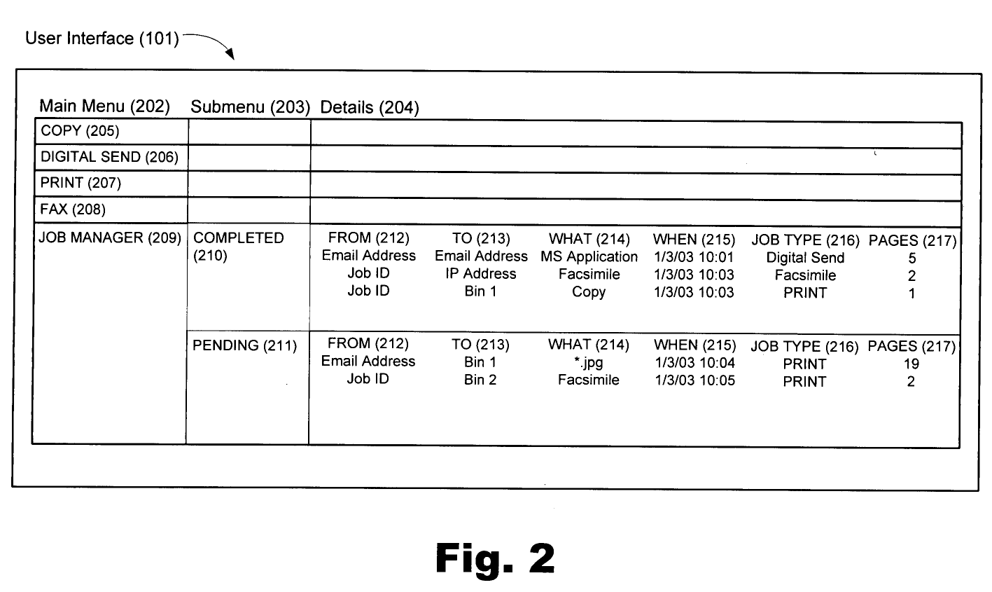

As previously mentioned, an MFD or other document processing device (102) may be used to create a hardcopy from a softcopy (e.g. printing a file or document). Moreover, an MFD may produce a hardcopy from a hardcopy (e.g. making a copy of a document), a softcopy from a hardcopy (e.g. scanning a document and storing the scanned image in memory), or a softcopy from a softcopy (e.g. digitally sending a scanned image, copying to a network drive, etc.). The present system and method manages all of these possible functions to be performed and the possibility of accommodating requests from multiple users. According to one exemplary embodiment, the user interface (101) may comprise a system of menus and submenus. These menus and submenus include various types of information and options. For example, the first or “main” menu (202, FIG. 2) may include a list of options a user may choose from. When an option is selected by a user, one or more submenus (203, FIG. 2) may appear presenting further options and/or information. Additionally, there may be more than one submenu (203) under each main menu (202) category. Navigating through these menus and submenus may include actuating directional arrow buttons (e.g. up, down, left, right), numbered buttons with corresponding numbers on each option, menu, submenu, etc. or an otherwise designated system of navigation (not shown).

FIG. 2 illustrates an exemplary embodiment of a user interface (101). As shown in FIG. 2, the user interface (101) of the document processing device (102; FIG. 1) may include a main menu (202) from which the user may select one or more options, a submenu (203), and a details component (204). According to one exemplary embodiment, the options available in the main menu (202) component of the user interface (101) may include the most frequently used functions on the document processing device (102; FIG. 1). For example, on an MFD, the available functions in the main menu (202) may include “Copy” (205), “Print” (207), “Fax” (208), and “Digital Send” (206). The main menu (202) may also provide access to a job manager (209) and the job manager's corresponding submenus. Moreover, as will be explained below, the user interface (101) may also be customized allowing a user to select which categories appear in the main menu (202) and the corresponding content of each category.

As shown in FIG. 2, a submenu (203) may contain one or more categories. The categories reflected in the submenu (203) may be chosen by either the document processing device manufacturer or by the user. According to one exemplary embodiment, the submenu (203) categories describe which type of job information may be found in a particular category. For example, the submenu (203) entitled “Completed” (210) may include job information on all of the jobs that have been processed by the document processing device (102; FIG. 1). Similarly, the submenu (203) entitled “Pending” (211) may include job information on all the jobs that have not yet been processed by the document processing device (102; FIG. 1) but are in a queue waiting to be processed. A more detailed explanation of possible submenu (203) categories will now be given.

The submenu (203) entitled “Details” (204) may be configured to display specific information about jobs such as, by way of example only, who sent the job request, who the recipient of the job is, the content of the document or file, when the job was originated and/or processed, the type of the job, the number of pages included in the job, etc. The information contained in the “Details” (204) submenu is separated into different categories which will be explained below. The titles that may be given to submenus may be similar to titles traditionally encountered in an e-mail display and may include, but are in no way limited to, “From” (212), “To” (213), “What” (214), “When” (215), “Job Type” (216), “Pages” (217), or any other title that may enable the user to quickly understand the content of the submenu (203).

The category entitled “From” (212) under the submenu (203) entitled “Details” (204) may contain job information identifying who sent or initiated a particular job on the document processing device (102, FIG. 1). This job information may include, but is not limited to, an Internet protocol (IP) address, machine address code (MAC) address, email address, employee number, room number, name, or any other identifier which may be used to determine who initiated a particular job.

The category entitled “To” (213) under the submenu (203) entitled “Details” (204) may contain job information identifying where or to whom the job is intended to be sent. This job information may include, but is in no way limited to, an IP address, a MAC address, an email address, a bin number, a room number, a name, or any other identifier which may be used to determine where or to whom a particular job is to be sent.

The category entitled “What” (214) under the submenu (203) entitled “Details” (204) may present job information identifying the file or document type. This job information may include, but is not limited to, file extensions, a Microsoft® application name (e.g. “Word” or “Excel” document) or other software application name, a file size, or any other file or document characteristics which may be used to identify what type of file or document is being processed.

The category entitled “When” (215) under the submenu (203) entitled “Details” (204) may display job information identifying when the file or document was processed or received for processing. This job information may include, but is in no way limited to, the date, the time, or any other information that may be used to determine when the file or document was processed or received for processing.

The category entitled “Job Type” (216) under the submenu (203) entitled “Details” (204) may present job information identifying the type of job that has been entered or received. It may also identify which function or functions the document processing device (102; FIG. 1) is to perform or has performed on the file or document. This job information may include, but is in no way limited to, print, facsimile, digital send, scan, copy, or any other information that may be used to determine which type of job is to be processed or has been processed.

The category entitled “Pages” (217) under the submenu (203) entitled “Details” (204) may include job information identifying the number of pages in a particular job. This job information may include, but is not limited to, the number of pages in a particular job, the number of originals, the number of copies, the number of cover sheets or attachments, or any other information the may be used to determine how many pages are in a particular job.

In contrast to the above-mentioned manufacturer designated menu structure, one exemplary embodiment of the user interface may allow the layout and content of the main menu (202) and the submenus (203) to be specified by the user. For example, in one sample layout illustrated in FIG. 2, the job manager (209) menu category has two submenus (203). The title of the first submenu (203) is “Completed Jobs” (210) and the title of the second submenu (203) is “Pending Jobs” (211). In such a system, job information on all jobs that have already been processed, whether entered by a user at the document processing device (102; FIG. 1) or sent to the MFD or other document processing device (102; FIG. 1) over a network (103; FIG. 1), could be found under the submenu (203) entitled “Completed Jobs” (210). Job information on jobs that had not yet been processed would be found and displayed under the submenu (203) entitled “Pending Jobs” (211). The user may select either submenu (203) (i.e. “Completed Jobs” or “Pending Jobs”) from the job manager (209) menu category in the main menu and view its contents using the user interface (101) of the MFD or other document processing device (102; FIG. 1).

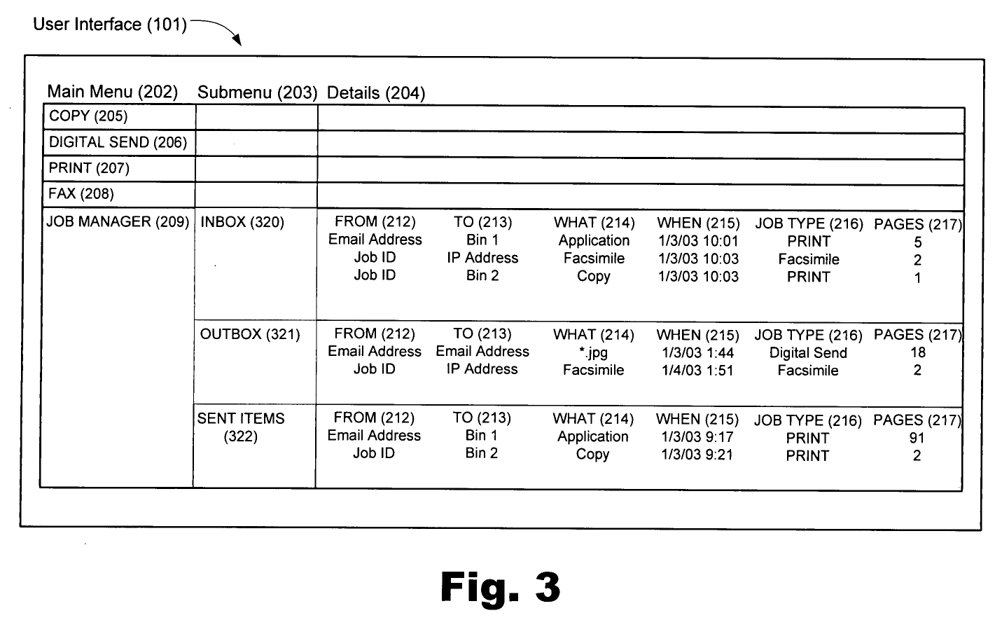

Alternatively, the user may specify a layout similar to that shown in FIG. 3 that includes three submenus (101) under the job manager (209) main menu (202) category. As shown in FIG. 3, a user may desire to configure the job manager (209) layout to resemble an e-mail information display. In keeping with this configuration, the submenu (203) may include an inbox (320), an outbox (321), and a sent items (321) submenu. The job information contained in the submenu (203) entitled “Inbox” (320) may include information for all jobs that have been received on that MFD or other document processing device (102; FIG. 1), whether from a user terminal (104; FIG. 1) or from a user at the MFD or other document processing device (102; FIG. 1). The “Outbox” (321) submenu (203) may include information for all jobs waiting to be processed by the MFD or other document processing device (102; FIG. 1). The “Sent Items” (322) submenu (203) may include information for all jobs that have previously been processed by that particular MFD or other document processing device (102; FIG. 1).

Similar to previously mentioned user interfaces (101), the user interface (101) illustrated in FIG. 3 shows that the main menu (202) may include frequently used functions. For example, the main menu (202) may include the categories “Copy” (205), “Send” (206), “Print” (207), “Fax” (208), and “Job Manager” (209). The user may specify a layout that includes “Inbox”, “Outbox”, and “Sent Items” submenus under each main menu (202) category in the user interface (101). In this manner, a user may obtain job information specific to each main menu (202) category (e.g. Copy (205), Print (207), Fax (208), Digital Send (206), etc.).

The user interface illustrated in FIG. 3 differs from the user interface illustrated in FIG. 2 in the manner in which it organizes job information. In the embodiment illustrated in FIG. 3, job information is organized into three categories: jobs that have been processed, jobs that are being processed, and jobs that are in a queue waiting to be processed. These categories may be chosen by the manufacturer or by the user and may be customized, fully or in part. The submenu (203) category titles may be chosen such that they describe which type of job information may be found in each particular category. Additionally, details (204) regarding each submenu (203) may be displayed including the afore-mentioned titles such as “From” (212), “To” (213), “What” (214), “When” (215), “Job Type” (216), “Pages” (217), or any other title that may enable the user to quickly understand the content of the submenu (203).

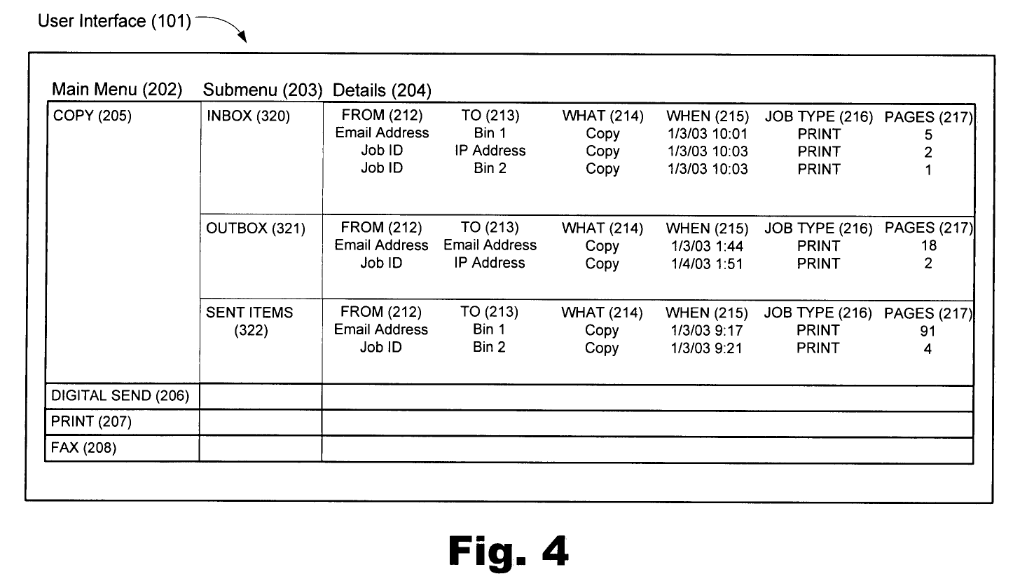

FIG. 4 illustrates an alternative embodiment in which a user interface (101) comprising a system of menus and submenus provides access to job information. Similar to FIGS. 2 and 3, the main menu (202) may include frequently used document processing device functions. For example, the main menu (202) may include the categories “Copy” (205), “Digital Send” (206), “Print” (207), and “Fax” (208). Moreover, the main menu (202) may be customized by the user as explained above. Specifically, the user may select the category titles and content that will appear in the main menu (202)

FIG. 4 differs from FIGS. 2 and 3 in the way that job information and job status information are organized. As shown in FIG. 4, the user may specify a layout that includes “Inbox” (320), “Outbox” (321), and “Sent Items” (322) submenus under each main menu (202) category. In this manner, a user may obtain job information specific to each main menu (202) category (e.g. Copy, Print, Fax, Send, etc.). For example, the main menu (202) category, “Copy” (205) may include a submenu (203) entitled “Inbox” (320) which may include job information on all copy jobs that are currently being processed by the MFD or other document processing device (102; FIG. 1). Similarly, the main menu (202) category entitled “Copy” (205) may also include a submenu (203) entitled “Outbox” (321) which includes job information on all copy jobs that have not yet been processed by the document processing device (102) but are in a queue waiting to be processed. Finally, in the embodiment illustrated in FIG. 4, the main menu (202) category entitled “Copy” (205) may also include a submenu (203) entitled “Sent Items” (322) which would include job information on all copy jobs that have been processed by the document processing device (102). While the embodiment illustrated in FIG. 4 displays the submenus (203) for the “Copy” (205) category, similar submenus (203) may be displayed for each main menu (202) category when selected.

The present system of menus and submenus may also include an integrated calendaring system. This calendaring system may be implemented according to user specifications in any of the menus, submenus, menu configurations, etc. The calendaring system may provide a user with information regarding all of the jobs processed in a given time period (e.g. a day, week, month, year, etc.). Alternatively, the user may specify to view only the jobs processed for a certain type of function in a given time interval. By way of example only, the user may select to view all print jobs completed within the last five days. Upon such a request, the present system of menus and submenus would display data collected regarding all the print jobs completed within the last five days. The layout and content of the calendar, calendaring system, job types displayed, etc. may be configured by the user, operator, owner, etc. of the MFD or other document processing device (102; FIG. 1).

Similar to customizable menus and submenus, methods of prioritizing job requests on an MFD or other on a document processing device (102; FIG. 1) are also customizable. For example, one method might include determining which job request takes precedence by establishing a rule that all jobs received will be processed in order of arrival. Alternatively, methods of prioritizing jobs may include, but are in no way limited to, giving precedence to jobs created at a specified time or within a set time interval, giving precedence to jobs created by a specified user or group of users, giving precedence to jobs created by a specified program, giving precedence to jobs initiated by a user physically at the printing device, giving precedence to jobs which are shorter in length or size relative to the job currently being processed, etc. The prioritization of jobs incoming or outgoing, whether initiated at the device or remotely, may be customized fully or in part according to user specifications.

In the case that a user initiates a job, whether from the user's terminal (104; FIG. 1) or at the document processing device (102; FIG. 1) and another job is initiated while the first job is processing, the first job and each subsequent job may be placed in a queue until the first job is finished processing. In some embodiments, jobs in queue will be processed according to precedence, i.e. in order of arrival. Alternatively, the jobs may be processed according to a set of priority regulations, for example, jobs initiated at the document processing device (102) (e.g. copying) may be given priority over jobs initiated over the network (103, FIG. 1) from a user terminal (104, FIG. 1).

In some cases, it may be desirable to upgrade existing document processing devices to implement the present method of managing job information. Existing document processing devices are often equipped with older, less versatile means of providing job information or may be equipped with no such user interface (101) at all. Some document processing devices, if found to have a suitable user interface and appropriate hardware, may be programmed and/or configured to use the present method of managing job information. The present method of managing job information may be programmed in with a firmware reburn or installed through a hardware upgrade.

Additionally, a user or owner may customize the present menu system to perform multiple actions with a single command. By way of example only, it may be desirable to store copies of each document handled by a document processing device. According to this embodiment, whenever a document is copied, faxed, printed, digitally sent, or otherwise processed by the MFD or other document processing device (102; FIG. 1), the document may also be copied and sent to a network drive or other storage unit for storage. Alternatively, a user may desire to automatically send a copy of the processed document to themselves via e-mail. This performance of multiple actions associated with one command is customizable and may be different for each document processing device user.

Each time a job is processed, details of the job or the entire job itself may be stored in memory on the document processing device itself or remotely. The memory may include, but is in no way limited to, a random-access memory (RAM), a tape drive, a hard drive, or any other volatile or non-volatile storage medium. In one embodiment, a log may be recorded listing each job, the job size, the job origin (both user and place), the time and date of processing, and any other characteristics specified by the document processing device user. When a copy of each processed job is saved to memory, the processed jobs may be organized in a number of different ways, which may be specified by the user. For example, the jobs may be organized into folders where each folder contains jobs created by one specified user. Alternatively, the jobs may be categorized according to size, date and time of processing, program type, etc. Moreover, menus, submenus, folders, and the like may be restricted to certain users and may implement some type of authentication in order to access a particular menu, submenu, or folder. Jobs saved in memory may be resent or reprocessed according to the specification of the user.

In conclusion, the present system for managing job information, in its various embodiments, organizes and displays job information in menus and submenus. In the present system, the title and content of each menu and submenu is customizable. This system allows users of a document processing device to ascertain the status of a job, whether the job has been processed, is being processed, or is in a queue waiting to be processed. With the present system, a user can also advantageously customize the prioritization of job processing, thus increasing the workflow and efficiency of the document processing device.

The preceding description has been presented only to illustrate and describe embodiments of the invention. It is not intended to be exhaustive or to limit the invention to any precise form disclosed. Many modifications and variations are possible in light of the above teaching. It is intended that the scope of the invention be defined by the following claims.

1. A method for managing document processing device job information comprising:
organizing said job information into menus and submenus; and
displaying said job information to a user.

2. The method of claim 1, wherein said menus and said submenus comprise:
a main menu including main menu categories: and
a submenu under each of said main menu categories.

3. The method of claim 2, further comprising:
navigating through said menus; and
displaying said submenus on a user interface when said menus are selected.

4. The method of claim 3, wherein said organizing said job information comprises organizing said job information according to processing date and time.

5. The method of claim 4, wherein jobs processed in a specified time frame are displayed on said user interface.

6. The method of claim 2, further comprising customizing said menus and said submenus according to a user specification.

7. The method of claim 6, wherein said customizing said menus and said submenus comprises establishing menu and submenu category names and content.

8. The method of claim 7, wherein said menu and submenu content comprises job information identifying completed jobs, pending jobs, jobs currently being processed, a source of said job, a destination of said job, a type of file or a document, when said job was processed, the type of job processed by said document processing device, a number of pages in said job, or a size of said job.

9. The method of claim 1, further comprising displaying said job information on a web page.

10. The method of claim 9, further comprising providing said web page with an embedded web server associated with said document processing device.

11. The method of claim 9, further comprising viewing said web page with a web browser.

12. The method of claim 1, further comprising displaying said job information on a user interface.

13. The method of claim 12, wherein said user interface organizes said job information into said menus and submenus.

14. The method of claim 13, wherein said user interface is configured to display job information regarding jobs that have already been processed.

15. The method of claim 13, wherein said user interface is configured to display job information regarding jobs that are currently being processed.

16. The method of claim 13, wherein said user interface is configured to display job information regarding jobs in a queue waiting to be processed.

17. The method of claim 16, further comprising processing said jobs in said queue according to a precedence.

18. The method of claim 16, further comprising processing said jobs in said queue according to a set of priority regulations.

19. The method of claim 18, wherein said priority regulations are specified by a user.

20. The method of claim 13, wherein said user interface is configured to display a plurality of submenus for each of said main menu categories.

21. The method of claim 20, wherein one of said plurality of submenus comprises job information on jobs currently being processed.

22. The method of claim 20, wherein one of said plurality of submenus comprises job information on jobs in a queue, waiting to be processed.

23. The method of claim 20, wherein one of said plurality of submenus comprises job information on jobs already processed.

24. The method of claim 1, further comprising storing said job information in a memory.

25. The method of claim 24, further comprising storing jobs processed in a memory.

26. The method of claim 1, further comprising requiring an authentication to access a restricted menu or submenu.

27. The method of claim 26, wherein said authentication comprises a login password.

28. A document processing device comprising:
a document processing device memory configured to store an embedded web server; and
a user interface;
wherein said user interface is configured to select and view job information organized into menus and submenus.

29. The document processing device of claim 28, wherein said document processing device memory comprises non-volatile memory.

30. The document processing device of claim 28, wherein said document processing device memory comprises volatile memory.

31. The document processing device of claim 28, wherein said user interface comprises a visual display.

32. The document processing device of claim 28, wherein said user interface comprises a navigation device.

33. The document processing device of claim 32, wherein said navigation device comprises one of directional buttons, numbered buttons, a keyboard, a keypad, a mouse, or a touch screen.

34. The document processing device of claim 28, wherein said device is communicatively coupled to a user terminal.

35. The document processing device of claim 34, wherein said user terminal comprises one of a personal computer, a laptop, a personal digital assistant, a cell phone, or a server.

36. The document processing device of claim 34, wherein said user terminal further comprises a web browser.

37. The document processing device of claim 34, wherein said device is communicatively coupled to said user terminal through a network.

38. A document processing device comprising:
receiving means for receiving job requests; and
display means for displaying job request information in menus and submenus.

39. The document processing device of claim 38, wherein said display means comprises a user interface.

40. The document processing device of claim 38, wherein said display means comprises a web page.

41. The document processing device of claim 38, further comprising customizing means for customizing said menus and said submenus.

42. The document processing device of claim 38, further comprising recording means for recording said job information.

43. The document processing device of claim 42, wherein said recording means comprises a memory of said documents processing device.

44. A processor readable medium having instructions thereon for:
storing job information in document processing device memory;
organizing said job information into menus and submenus; and
displaying said menus and submenus on a user interface or web page.

45. The processor readable medium of claim 44, wherein said processor readable medium is associated with a document processing device.

46. The processor readable medium of claim 44, wherein said processor readable medium is associated with a remote server.
